(19) United States
(12) Patent Application Publication
(10) Pub. No.: US 2016/0183731 A1
(43) Pub. Date: Jun. 30, 2016

(54) COLLAPSIBLE ARTICLE

(71) Applicants: Ran MERKAZY, London (GB); RMDLO LIMITED, Northamptonshire (GB)

(72) Inventor: Ran Merkazy, London (GB)

(21) Appl. No.: 14/909,729

(22) PCT Filed: Aug. 7, 2014
(86) PCT No.: PCT/GB2014/000312

§ 371 Date: Feb. 2, 2016

(30) Foreign Application Priority Data
Aug. 9, 2013 (GB) 1314346.6

(51) Int. Cl. A47J 43/24; A47G 19/02

(52) U.S. Cl. CPC A47J 43/24; A47G 19/02

(57) ABSTRACT

A collapsible article, for example a colander (50; 60) or bowl (10; 90), comprises a plurality of semi-rigid, elongate leaves (12a-c; 52a-c) each having first and second ends. The first ends are attached together and the second ends are attached together. The leaves are moveable to reconfigure the article from one to the other of: an expanded configuration in which the leaves are spread to form a bowl shape, and a collapsed configuration. The article, when in the collapsed configuration, is of less volume than the bowl-shaped article. The leaf is typically less curved longitudinally in the collapsed configuration than in the expanded configuration.

### FIELD OF INVENTION

The invention relates generally to a collapsible dome-shaped article, and in particular to a collapsible container such as a collapsible colander or bowl.

### BACKGROUND

Containers such as bowls and colanders can be difficult to store. They take up a large amount of space in kitchen cabinets, in dishwashers, on draining boards, etc. Such items can also be cumbersome to retrieve from and put in cabinets. There are also circumstances outside the kitchen when it is desirable for a container to be compact, for example when camping.

A known collapsible colander, disclosed in US2010/0170840, has three parts: a rigid top rim, a flexible pleated centre band and a rigid base. The flexible centre band allows the container to collapse to about one-third of its original height. Such a colander may be difficult to expand or collapse, and/or may not be robust or self-supporting when expanded and filled with contents.

Known collapsible strainers have also been formed entirely from a flexible material. This allows the strainer to be flattened, but because the material of the container is not sufficiently rigid to be self-supporting, the container is liable to collapse when placed unsupported on a surface and filled.

It is an object of the present invention to address drawbacks to known containers.

### SUMMARY OF THE INVENTION

According to the present invention, there is provided a collapsible dome-shaped article, comprising a plurality of semi-rigid, elongate leaves each having a first end and a second end, wherein the first ends are attached together and the second ends are attached together, and wherein the leaves are moveable to reconfigure the article from one to the other of: an expanded configuration in which the leaves are spread to form a dome shape, and a collapsed configuration.

Preferably the dome-shaped article is a container, such as a bowl or a colander. Thus, at least some of the drawbacks to known containers mentioned above are addressed. In the collapsed configuration, the article, whose volume is considered to include the space in the dome, is of less volume than in the expanded configuration. Not only is this volume reduced, but the space required for storage may be further reduced since there is reduced waste space around the collapsed article. Thus, the invention allows for efficient use of space. Also, the article may be a shape that is practical. For example, where the collapsed article is generally elongate, it may be convenient to store in a drawer. The dome-shaped article may also include means by which the collapsed article can be conveniently hung, for example, where the article is a container, from a hook in a kitchen.

The height of the dome-shaped article in the collapsed configuration is preferably less than a quarter of the height of the article in the expanded configuration, preferably still less than an eighth of the height. Also, conveniently, the width of the article in the collapsed configuration may be less than the width of the article in the expanded configuration. For example, the width of the article in the collapsed configuration half way along its length may be less than a third of the width, preferably about a quarter of the width. Relatively low height and width may advantageously result in a collapsed article that may be conveniently stored, for example in a drawer. Preferably the volume of the article including the volume intended for holding contents in the collapsed configuration is less than a tenth of the volume in the collapsed configuration. Due to the convenient shape that the collapsed article may have, the space required for storage may be a twentieth of the space required to store the expanded container.

Such a collapsible article is also preferably self-supporting in the expanded configuration, and so is not liable to collapse under its own weight or, where the article is a container, the weight of its contents.

Conveniently, in the collapsed configuration the leaves may substantially overlie each other. The leaves are preferably less curved longitudinally in the collapsed configuration than in the expanded configuration—the leaves are preferably substantially flat in the collapsed configuration.

The article may further comprise first attachment means for attaching the first ends of the leaves, and second attachment means for attaching the second ends of the leaves. The first attachment means may comprise, for each leaf, a first attachment part attached to the first end of the respective leaf, the first attachment parts being arranged to attach the first ends of the leaves together, and the second attachment means may comprise, for each leaf, a second attachment part attached to the second end of the respective leaf, the second attachment parts being arranged to attach the second ends of the leaves together, wherein each of the first and second attachment parts are arranged to permit the leaves to be moved for reconfiguring of the article.

The leaves may consist of a first, at least one intermediate and a last leaves, and movement of the first of the leaves in the expansion direction relative to the last of the leaves may cause movement in the expansion direction of the at least one intermediate leaf until the container is fully expanded.

Each attachment part may be engaged with the one or two adjacent attachment parts. In other words, the attachments parts attached to the first and last of the leaves may each be engaged with the one adjacent attachment part and the attachment parts adjacent the intermediate leaves may each be attached to both adjacent attachment parts.

The at least one intermediate leaf may include a plurality of leaves, and the movement of the first of the leaves in the expansion direction may pull the intermediate leaves sequentially from the intermediate leaf adjacent the first leaf to the intermediate leaf adjacent the last leaf. In other words, the movement of the first of the leaves may pull the adjacent intermediate leaf in the expansion direction, which pulls the next adjacent intermediate one of the leaves in the expansion direction, and so on until the last leaf. This is a convenient way of spreading the leaves.

Each leaf and the attached first attachment part and attached second attachment part are preferably formed of a single piece of material. The material of each piece is preferably cut from a larger piece of material in a single-step manufacturing process.

The article may further comprise a biasing means for biasing the article to an expanded configuration. The biasing means may comprise a resilient means fixedly attached to a first of the first attachment parts and a last of the first attachment parts and arranged to bias the article to the expanded configuration.

Whether biasing means are present or not, when the article is in the collapsed configuration the geometry of the leaves may prevent expansion, such that, upon manual operation of the leaves the article may expand. Thus, an additional lock means to lock the article in a collapsed configuration is not essential.

Alternatively, the biasing means may be for biasing the article to the collapsed configuration. In this case, the geometry of the leaves may prevent collapse when the article is in the expanded configuration.

Each attachment means may include first and second lobes, the first lobe attached to a first of the leaves and the second attached to the second of the leaves, such that, when the article is in the collapsed configuration, manual operation of the lobes causes spreading of the leaves to the expanded configuration.

Additionally or alternatively, at least one of the attachment means may further comprise a lock means for releasably locking the leaves such that the article is in the collapsed and/or expanded configuration. The lock means may be operable to release the leaves, whereupon the article can expand to the expanded configuration or collapse to the collapsed configuration either by action of biasing means or upon manual operation.

Preferably, the plurality of leaves comprises 5 to 12 leaves. The leaves are preferably shaped so that when the article is in the expanded configuration, an edge of at least some, preferably all but the last, of the leaves abuts against a surface of an adjacent one of the leaves. The leaves may press against said surface so that when the article is in the expanded configuration, liquid cannot egress between leaves.

Preferably, each leaf is configured to arc with predetermined curvature and to have a predetermined shape so that the article has a predetermined dome shape when in the expanded configuration. The predetermined curvature and shape are preferably such that the article can be expanded and collapsed without need for undue force.

The leaves may be arranged to spread so as to, in the expanded configuration, enclose contents of the article. For example, the leaves may extend to form a ball-shaped article. Advantageously, contents of the article is then covered.

The article may be a collapsible straining device, for example a strainer, colander or sieve. In this case, each leaf may include a plurality of straining holes. Where the article includes straining holes, the straining holes of each leaf may be configured so that the leaf arcs with a predetermined curvature and the thickness of the leaf is constant. Alternatively, rather than including straining holes, the straining device may strain by allowing drainage of liquid between leaves.

Alternatively, one or more leaves may include portions of mesh to allow drainage or sifting.

The leaves may include, at least at edges thereof, a coating, which, when the article is in the expanded configuration forms a seal between adjacent leaves.

As mentioned above, the article may be a container such as a collapsible bowl or colander. Alternatively, the article may be a measuring cup, or, where the material of the article is resistant to deformation on application of heat and transmits heat, a pot. The container may include a detachable or permanent handle, and the first or last leaves may be attached to the handle in a manner that does not prevent collapsing and expanding of the article.

The article may further comprise a guard over outer edges of first and last of the leaves. Thus, any risk of injury resulting from sharpness of the outer edges is prevented.

Use of the dome shaped article as a container is not the only possible application. The dome-shaped article may be configured as a wave reflector to focus, concentrate and/or reflect at least some waves incident on the dome-shaped article. The waves may be electromagnetic or mechanical waves. In an aspect of the invention, an antenna may comprise such a dome-shaped article, wherein the dome-shaped article is configured to focus at least some waves. Preferably the dome-shaped article is parabolic and reflects signals to a focal point. For example, such an antenna may be used in a satellite dish. Preferably the antenna comprises a feedhorn and means for attaching the feedhorn to the dome-shaped article to receive signals reflected by the dome-shaped article. Advantageously, the antenna may be portable. The dome-shaped article may also be configured for application in photography as a light reflector to direct light to a particular subject or scene. The dome-shaped article may also be used in a lamp shade.

In another aspect, the dome-shaped article may be configured as a protector. For example, the dome may be used in catering, for placing over food and drink for protection. The dome may be modified so as to be used as the dome of an umbrella.

Thus, the article may be used as a container or straining device, a protector, or a means for focusing, concentrating and/or reflecting waves.

### BRIEF DESCRIPTION OF FIGURES

For better understanding of the present invention, embodiments will now be described, by way of example only, with reference to the accompanying figures in which:

FIGS. 1A and 1B are respectively a perspective view and a side view of a bowl comprising a plurality of leaves, in accordance with a first embodiment of the invention;

FIG. 2 is a perspective view of the bowl when collapsed;

FIG. 3 is a view of parts of the bowl;

FIGS. 4A and 4B are perspective views of a portion of two leaves and a fastening part associated with each leaf, to illustrate how adjacent leaves may be engaged;

FIG. 5A to 5C are views of parts of the bowl, to illustrate how the bowl is manufactured;

FIG. 6 is a view of part of the bowl, to illustrate how the bowl can be operated;

FIGS. 7A to 7D are respectively a plan, a side, a perspective, and another side views of a colander when expanded;

FIG. 8 is a perspective view of the colander when collapsed;

FIGS. 9A and 9B are respectively perspective and side views of a colander in a second embodiment in an expanded configuration;

FIG. 10 is a view of parts of the colander shown in FIGS. 9A and 9B, to indicate the configuration of a locking mechanism of the colander when the colander is collapsed;

FIG. 11 is a view of parts of the colander shown in FIGS. 9A and 9B, to indicate the configuration of a locking mechanism of the colander when the colander is expanded;

FIG. 12 is a view of parts of the colander shown in FIGS. 9A and 9B when the colander is collapsed;

FIGS. 13A and 13B are respectively perspective and side views of a bowl in a variant on the second embodiment;

FIG. 14 is a view of the bowl shown in FIGS. 13A and 13B when collapsed; and

FIGS. 15A to 15C illustrate how the bowl shown in FIGS. 13A and 13B is manufactured;

FIG. 16 is a view of parts of the bowl shown in FIGS. 13A and 13B to illustrate how the bowl is expanded;

FIG. 17 is view of the bowl shown in FIGS. 13A and 13B with a cover and a lip; and

FIG. 18 is a view of a ball-shaped container, in accordance with another embodiment of the invention.

### DETAILED DESCRIPTION OF EMBODIMENTS

Like reference numerals are used to denote like parts throughout.

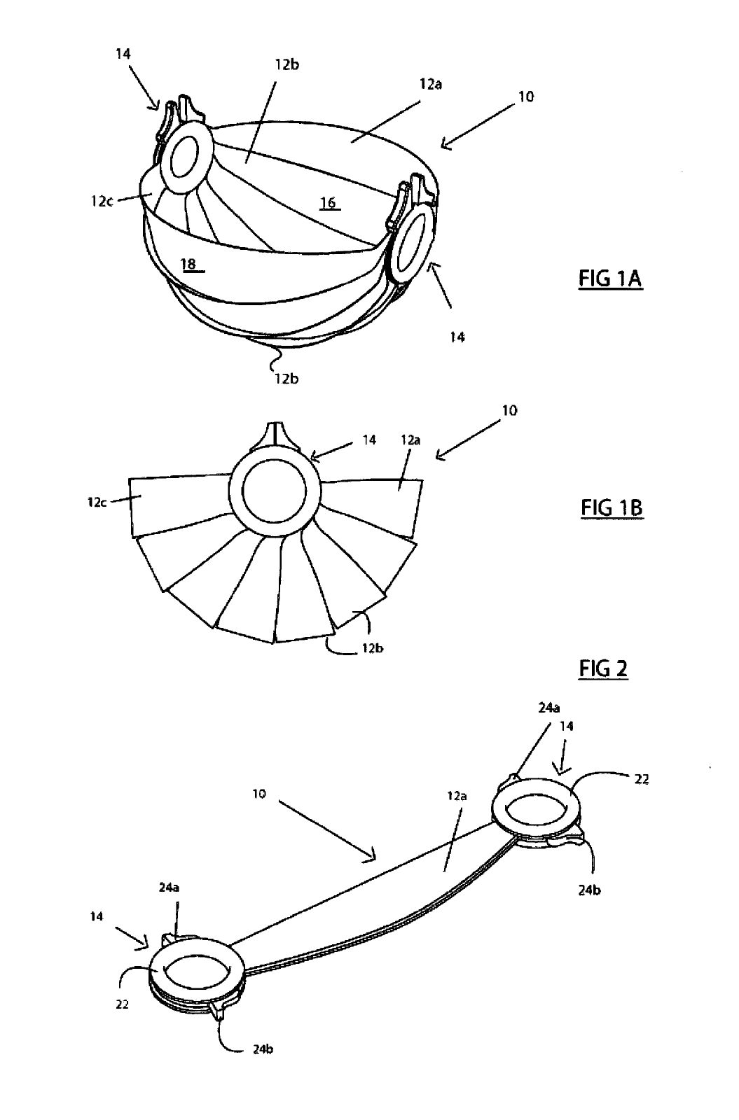

In a first embodiment, a collapsible container can be configured in a first, expanded configuration in which it is in the form of a bowl, or in a second, collapsed configuration. In FIGS. 1A and 1B, such a bowl 10 is in the expanded configuration. The bowl 10 comprises several resilient, semi-rigid elongate leaves 12a-c and a pair of attachment means in the form of fastening assemblies, generally indicated at 14. In FIG. 2, the bowl 10 is in the collapsed configuration, with the leaves 12a-c overlying one another. The leaves 12a-c arc in the expansion configuration and are substantially flat in the collapsed configuration. By “semi-rigid”, it should be understood that the leaves can flex to be arcuate from the collapsed configuration in which the leaves are flat on manual operation of the bowl 10, and the material of the leaves is sufficiently rigid to be self-supporting.

The leaves are arranging in a sequence. The leaves 12a-c consist of a first leaf 12a, intermediate leaves 12b, and a last leaf 12c. The words “first”, “intermediate” and “last” are to conveniently refer to the positions of the leaves in the sequence.

Each leaf 12a-c has a first end and a second end. Each fastening assembly 14 comprises an attachment part in the form of a fastening part for each leaf. Each fastening part is integrally formed with its respective leaf 12a-c. The first end of each leaf 12a-c is attached to a one of the fastening assemblies 14, and the second end of each leaf 12a-c is attached to the other of the fastening assemblies 14. In the expanded configuration, each leaf 12a-c arcs between the fastening assemblies 14, and the leaves 12a-c are spread so as to collectively form a bowl-shaped container.

Each leaf 12a-c has an inner surface 16 and an outer surface 18. The inner surfaces 16 of the leaves form the interior surface of the bowl 10 when expanded and the outer surfaces 18 form the exterior. The leaves 12a-c are shaped so that when in the expanded configuration, one of the edges of each of the first and intermediate leaves 12a, 12b abuts, or is close to, the leaf adjacent that edge, along the length of the edge, so that solid matter placed in the bowl 10 substantially does not escape through any gaps between leaves. The size of gap that is acceptable is dependent on the intended contents of the bowl 10.

The fastening assemblies 14 each further include a casing 22 and a pull lobe 24a, 24b. The casing 22 is absent in FIG. 1B. The fastening assemblies 14 are configured to allow pivoting movement of the leaves 12a-c with respect to each other, such that the leaves move in reconfiguration of the bowl 10 to and from the expanded configuration and the collapsed configuration. In the collapsed configuration, the leaves 12a-c are arranged so that the outer surface 18 of the first and intermediate leaves 12a, 12b overlies the inner surface 16 of a respective adjacent one of the intermediate and last leaves 12b, 12c.

The storage volume of the bowl 10 is the space required for its storage and is considered to include the space into which contents can be placed. The bowl 10 takes up much less space when collapsed than when expanded.

As mentioned above, each fastening assembly 14 comprises, for each leaf 12a-c, an attachment part in the form of the fastening part integrally formed with the respective end of the respective leaf. For each fastening assembly, the fastening parts formed with the first, intermediate and last leaves 12a-c are referred to as first, intermediate and last fastening parts respectively.

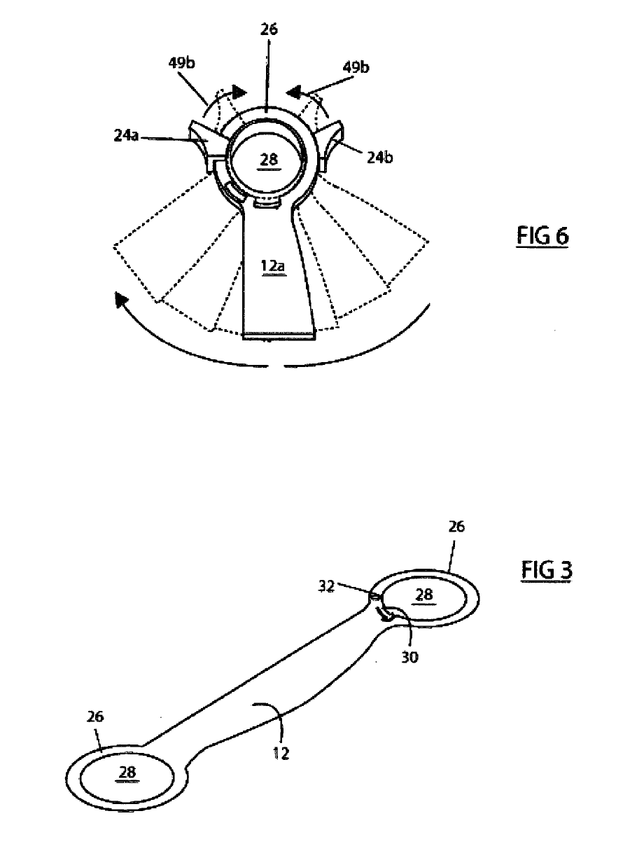

The manufacture of the bowl 10 will now be described, which will aid understanding of the construction of the interior mechanism. A plurality of pieces are formed, one of which is shown in FIG. 3, using conventional metal sheet stamping equipment. Each piece comprises a leaf with fastening parts integrally formed therewith at first and second ends thereof. Each fastening part comprises a substantially annular plate 26 having an aperture 28 therethrough and having an engagement arm 30 therein for interlocking with an adjacent fastening part. The plate 26 also includes a slit 32 therein through which to receive an engagement arm 30 of an adjacent fastening part.

In FIG. 3, only one of the fastening parts attached to a leaf 12a, b, c is shown to include an engagement arm 30 and a slit 32, but in practice each fastening part has a respective engagement arm and slit.

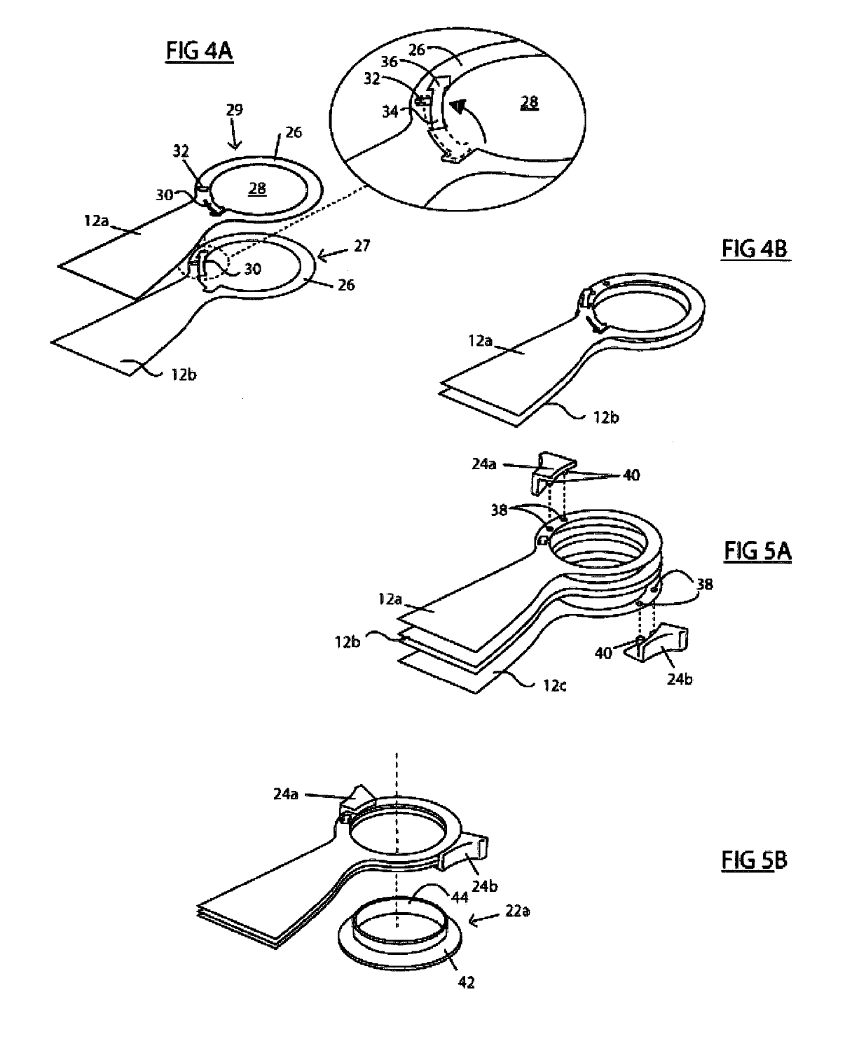

Referring to FIG. 4A, the engagement arm 30 of one of the fastening parts 27 is bent so that it can extend through the slit 32 in an adjacent fastening part 29. In FIG. 4B, the engagement arm 30 is shown extending through the slit 32 in the adjacent fastening part 29. The engagement arm 30 has a slide portion 34 and a stop portion 36, wherein the slide portion 34 is shaped to slide in the slit 32. The stop portion 36 prevents disengagement of the engagement arm 30 from the adjacent fastening part.

Although not visible in the figures, the slit 32 is a two-width slit, a portion of which is sufficiently wide to allow the engagement arm 30 to be slid through the slit 32 in manufacture, and another portion of width to allow the slide portion 34 to slide in the slit 32 but sufficiently narrow as to prevent escape of the stop portion 36. The engagement arm 30 and the slit 32 are arranged so that the slide portion 34 can slide in the narrower portion of the slit 32 on expanding or collapsing of the bowl 10, without the stop portion 34 of the engagement arm 30 of the fastening part 27 returning through the slit 32 to disengage from the adjacent fastening part 29. The same arrangement of an engagement arm 30 and a slit 32 is described in relation to the second embodiment described below, and further details may be understood from that.

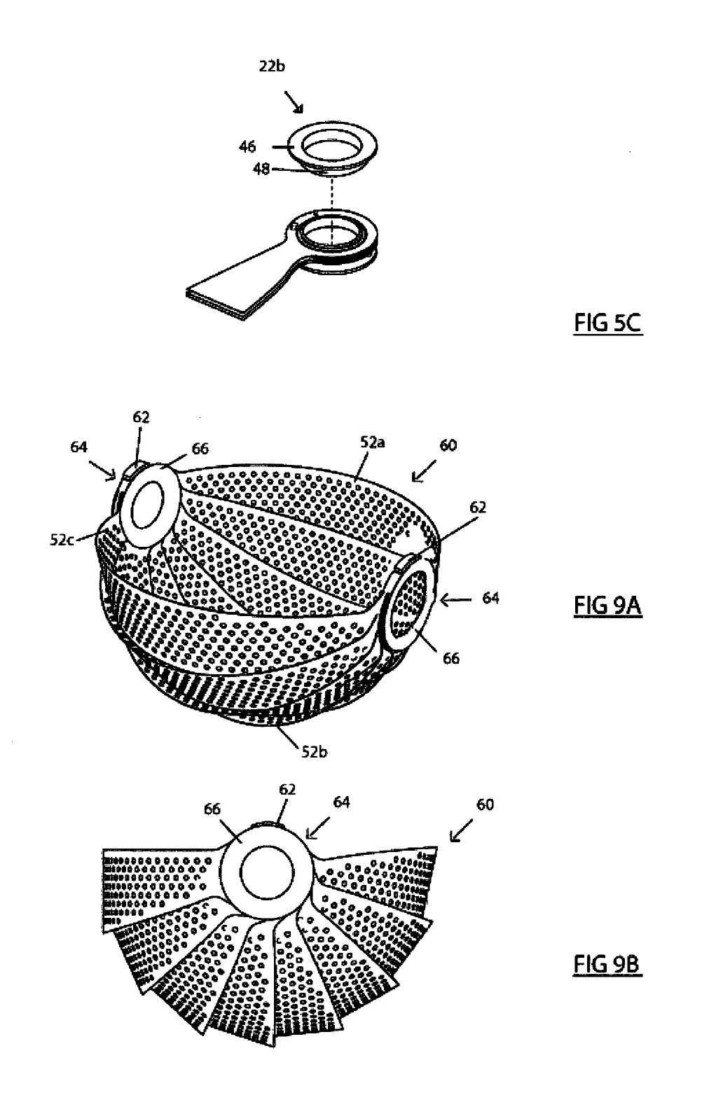

As can be seen in FIG. 5A, the first and last of the fastening parts each includes a pair of spaced holes 38 therethrough and each pull lobe 24a, 24b includes a pair of correspondingly spaced protrusions 40. The pull lobes 24a, 24b can be attached to a respective one of the first and last fastening parts by pressing the protrusions 40 into the holes 38.

The casing 22 comprises first and second parts 22a, 22b. Referring to FIG. 5B, the first casing part 22a comprises an annular cover portion 42 arranged to cover the annular plate 26 of the last fastening part and a portion of the pull lobes 24a, 24b extending over the last fastening part. The first casing part 22a further comprises a sleeve 44 arranged to extend into the apertures 28 of the fastening parts.

Referring to FIG. 5C, the second casing part 22b similarly comprises an annular cover portion 46 arranged to cover the annular plate 26 of the last fastening part, and a tubular portion 48 for extending into the sleeve 44 of the first casing part 22a. The first and second casing parts 22a, 22b are attached together, for example by adhesive. Alternatively, the sleeve can have an internal thread and the tubular portion can have an external thread for engaging with internal thread. The fixing together of the first and second casing parts 22a, 22b also prevents the pull lobes 24a, 24b from coming detached from the first and last fastening parts.

Referring to FIG. 6, in use the leaves 12a-12c can be spread by movement in an expansion direction of the pull lobes 24a, 24b in the direction of the arrows 49a, 49b. Movement of the pull lobes 24a, 24b towards one another initially causes the first leaf 12a to spread relative to the adjacent intermediate leaf 12b. The first leaf 12a spreads, such that the sliding portion 34 of the engagement arm 30 moves in the slit 32 of the adjacent fastening part 29, until the stop portion 36 of the engagement arm 30 abuts against the adjacent fastening part 29. Thereafter, movement of the first leaf 12a pulls the adjacent intermediate leaf 12b until the stop portion 36 of the engagement arm 30 of that intermediate leaf 12b abuts against the next adjacent leaf 12b, and so on. As the leaves 12a-c are spread out, they flex to a bowl-shape due to the shape and configuration of the leaves. Thus, the leaves 12a-c spread out sequentially to form the bowl shape.

To collapse the bowl, the leaves 12a-c are simply pushed together.

The bowl 10 stays in the collapsed configuration due to friction between the leaves 12a-c and inherent locking due to the geometry of the bowl when collapsed. Similarly, the bowl 10 stays in the expanded configuration due to inherent locking due to the geometry of the bowl 10.

The capability of the leaves 12a-c to spread out and flex to form a bowl of the desired shape requires the leaves 12a-c to have certain characteristics. The leaves 12a-c are configured so that the flexibility of each leaf 12a-c is substantially constant along its length. Each leaf 12a-c is not of constant thickness. In practice, the area of each transverse cross-section is approximately constant. This results in each leaf 12a-c naturally arcing in a part-circular manner. Additionally, the shape of each leaf 12a-c is predetermined so that the leaves urge each other to flex, so that the bowl 10 is approximately hemispherical when in the expanded configuration and may be expanded and collapsed without need for excessive force. In alternative embodiments, the bowl, when expanded may be other than hemispherical—the flexibility of the leaves 12a-c and their shapes can be predetermined so that the bowl has a desired curvature. For example, the leaves may flex to have parabolic curvature.

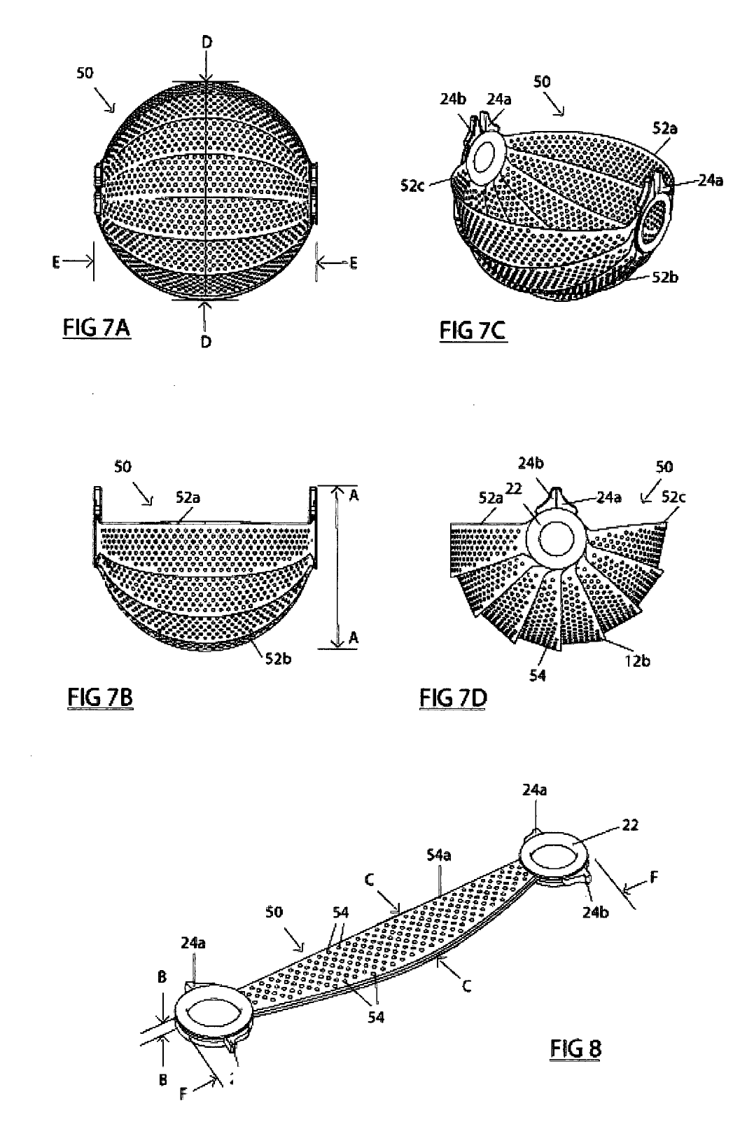

In a variation on the first embodiment, described with reference to FIGS. 7A to 7D and 8, the container, when expanded, is in the form of a colander 50. With the exception of the leaves, the colander 50 comprises the same parts as the bowl 10 of the first embodiment, and is operated in the same way. Each leaf 52a-c has a plurality of straining holes therethrough, some of which are indicated at 54. The holes 54 allow drainage of liquid from mixed solid/liquid matter placed in the colander. The straining holes 54 are sized to prevent solid matter for use with which the colander 50 is intended, typically foods such as pasta or vegetables, from passing through them. In some embodiments, the straining holes 34 may be sufficiently small to prevent foods such as rice passing through.

Like in the first embodiment, the leaves 52a-c are configured so that the flexibility of each leaf 52a-c is substantially constant along its length and the shape of each leaf is predetermined so that the colander, when expanded, is approximately hemispherical. In order to so predetermine the flexibility, the straining holes 54 and the thickness of the leaves 52ac are arranged so that the amount of material in transverse cross-sections is substantially constant. Alternatively, the thickness of the leaves 52a-c is constant and the flexibility may be predetermined exclusively by suitable configuration (i.e. location, size, shape and/or number) of the straining holes 54. The shape and flexibility of the leaves may be predetermined so that the curvature of the colander is other than hemispherical.

The storage volume of the colander 50 is the space required for its storage and is considered to include the space into which contents can be placed. The colander 50 takes up much less space when collapsed than when expanded. The height of the colander 50 when fully expanded is indicated in FIG. 7B at A-A. The height of the colander 50 when collapsed is indicated in FIG. 8 at B-B. As can be seen, the height when collapsed is much less than the height when expanded. The width of the colander 50 when collapsed is shown at C-C in FIG. 8. The width is also much less than the width of the colander 50 when expanded, indicated at D-D in FIG. 7A. The width of the colander 50 midway along the length of the leaves 12a-c is less than a third of the corresponding width of the colander 50 when expanded. The length of the bowl 10 when expanded is indicated at E-E in FIG. 7A, and is indicated at F-F in FIG. 8 when collapsed. The length of the colander 50 is slightly longer when collapsed than when expanded.

It will be appreciated that all the embodiments described with reference to FIGS. 1 to 17 may all be identical or similar in their lengths, widths and heights. In a prototype, the length A-A is about 150 mm, the length B-B is about 16 mm, the length C-C is about 75 mm, the length E-E is about 300 mm, the length E-E is about 300 mm, and the length F-F is about 420 mm. In this case, the volume of the collapsed colander is about 28 times less than the volume when expanded. In this prototype there are eight leaves and each leaf pivots about 27 degrees relative to the adjacent leaf.

In a second embodiment described with reference to FIGS. 9A, 9B, 10 and 11, the container is again in the form of a colander 60, but rather than the colander locking in the collapsed configuration due to the geometry of the leaves, the colander 60 includes a lock mechanism for locking the colander in the collapsed configuration. Such a lock mechanism includes a button 62.

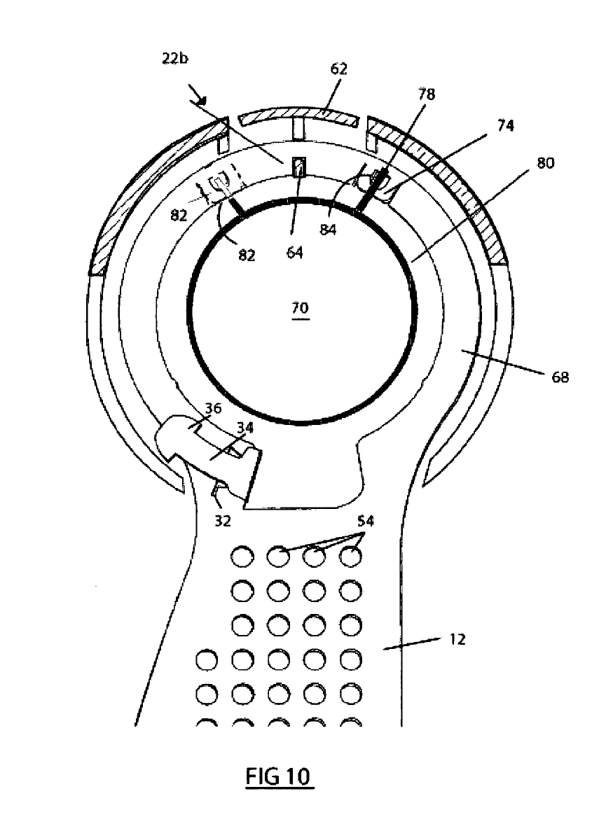

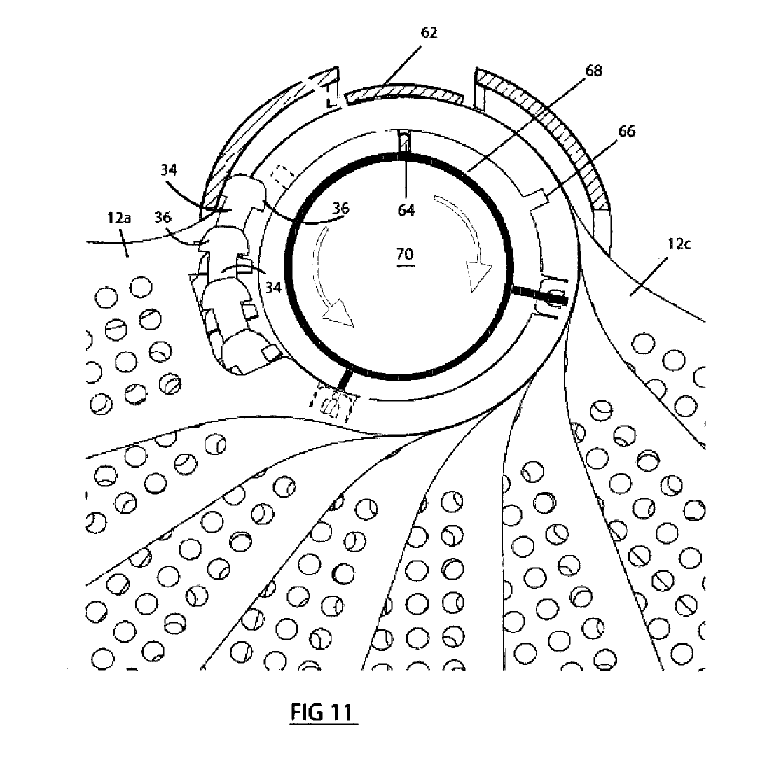

The colander 60 includes leaves 52a-c like the leaves of the colander 50 described above, and fastening assemblies 64. The fastening assemblies 64 include a casing 66, the button 62, an interior mechanism and fastening parts. FIGS. 10 and 11 illustrate the interior mechanism of one of the fastening assemblies 64 and a portion of each of the leaves 52a-c is shown.

Each fastening assembly includes a fastening part for each leaf 52a-c. Like in the first embodiment and the variant consisting of the colander 50, each fastening part includes a substantially annular plate 68 having an aperture therethrough, Each fastening part also includes an arrangement of an engagement arm 30 and a slit 32, and each fastening part up to the last is engaged with the next fastening part in the sequence using the engagement arm 30 and two-width slit 32.

Each fastening assembly 64 also includes a biasing arrangement to bias the colander 60 into the expanded configuration. The biasing arrangement is provided by a pair of tongues 72, 74 extending from the plate 68 of first and last fastening parts. Each tongue 72, 74 has an eyelet 76, 78 therethrough. The tongues 72, 74 extend away from the intermediate fastening parts adjacent the first and last fastening parts respectively. A resilient member in the form of a torsion spring 80 of similar height to the height of the stacked plates 68 is located substantially within the apertures 70 of the plates 68. The torsion spring 80 has a first end 82 attached to the first fastening part and a second end 84 attached to the last fastening part, and is arranged to bias the fastening parts such that the colander 60 is biased to the expanded configuration. The first and second ends 82, 84 are respectively attached to the first and second fastening parts by extending through the eyelets 76, 78 in the tongues 72, 74.

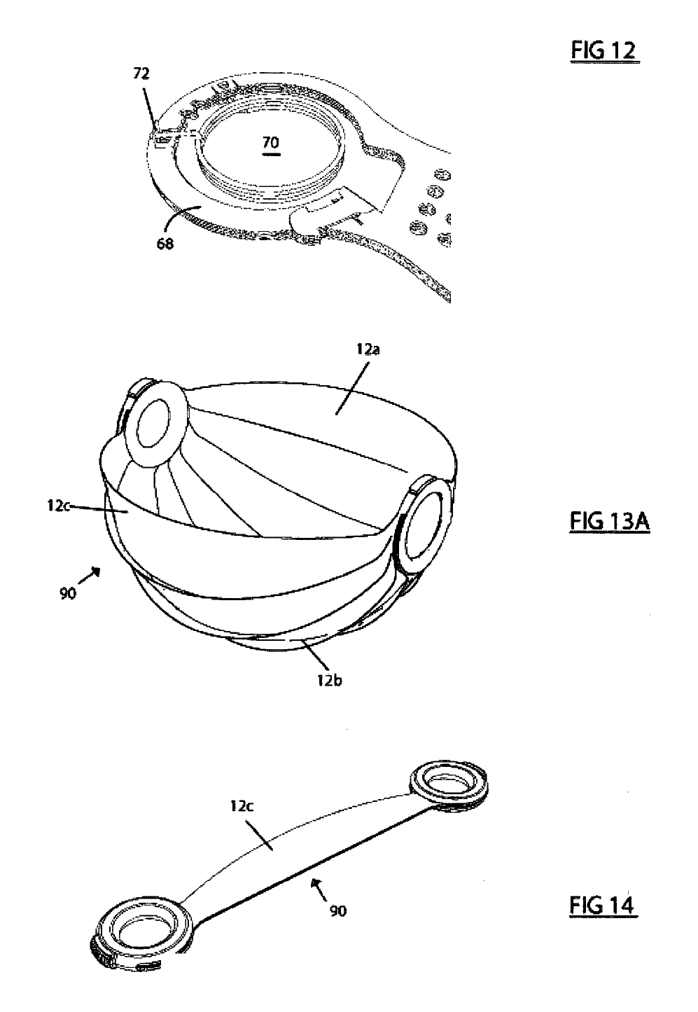

As can be seen in FIG. 12, each fastening part has a pair of tongues formed in its plate 68, of which the tongues 72 and 74 are only two. Each tongue is formed by a pair of parallel cuts extending from an edge of the aperture 70 part way to the outer edge of the plate 68. It should be understood that only the tongues 72, 74 of the first and last fastening parts are utilised. The other tongues are provided so that each fastening part can be made identical which facilitates manufacture.

The lock mechanism, shown in greater detail in FIGS. 10 and 11, includes the button 62, a locking tooth 64, a spring (not shown), and, in each plate 68, a recess 66. The recesses 66 of each plate 26 are located so that they are aligned when the colander 60 is collapsed. The button 62 and the locking tooth 64 are arranged so that each is biased by the spring, the button 62 into an outward position and the locking tooth 64 to engage in the recesses 66 in the plates 68 when the recesses 66 are aligned. When so engaged the locking tooth 64 prevents expansion movement of the leaves 12a-c. When depressed, the button 62 causes the locking tooth 64 to disengage from the recesses 66, thereby allowing the leaves 12a-c to respectively pivot and the colander 60 thereby to expand.

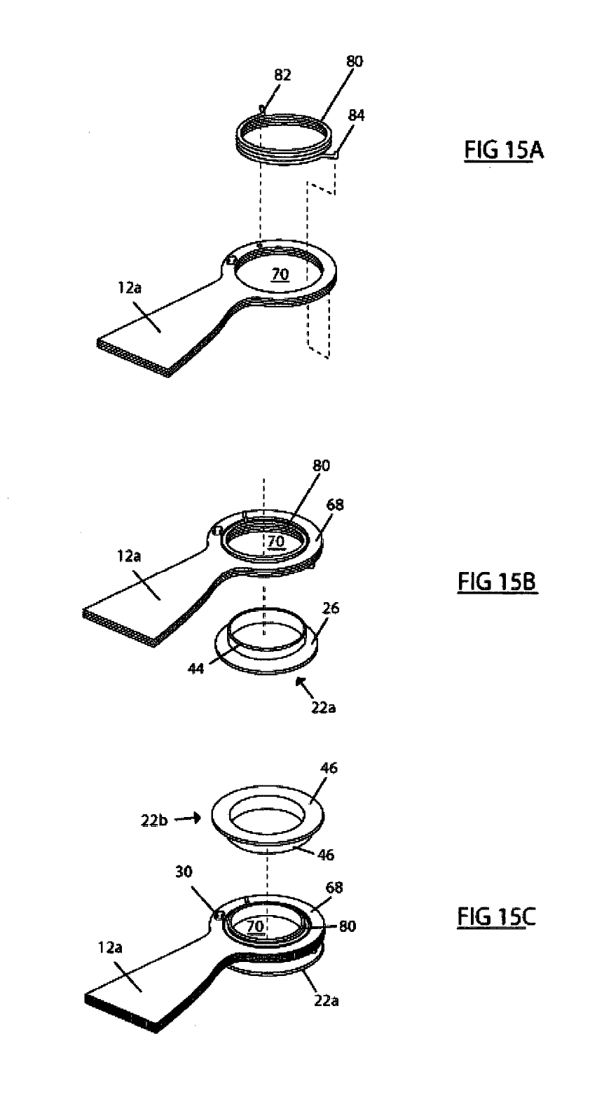

Referring to FIGS. 13A, 13B and 14, in a variant on the second embodiment the collapsible container is in the form of a bowl 90. The bowl 90 is identical to the colander 60 shown in FIGS. 11A-C, and is made, expanded and collapsed in the same way, except the leaves are the same as those described in relation to the first embodiment.

Manufacture of the bowl 90 will now be described, which aids understanding of the construction of the bowl 90 and the colander 60. Initially, pieces comprising the leaves 12a-c and the fastening parts, are formed using conventional metal stamping equipment, so that the ends of each leaf 12a-c each have a fastening part integrally formed therewith. The engagement arm 30 is then bent and inserted through the slit 32 of the adjacent fastening part, such that all leaves 12a-c are respectively engaged.

The tongue 72 on the first fastening part and the tongue 74 of the last fastening part are then bent so that the first and second ends 82, 84 of the torsion spring 80 can be engaged in the eyelets 76 and 78 in the tongues 72, 74. The ends 82, 84 of the torsion spring 80 are then engaged in the eyelets 76, 78 accordingly, as best seen in FIG. 12.

Like in the first embodiment, the casing comprises a first casing part 22a and a second casing part 22b. Referring to FIG. 15B, the first casing part 22a comprises an annular cover portion 26 arranged to cover the annular plate 68 of the last fastening part. The first casing part 22a further comprises a sleeve 44 arranged to extend into the apertures 70 of the fastening parts.

Referring to FIG. 15C, the second casing part 22b similarly comprises an annular cover portion 46 arranged to cover the annular plate 68 of the last fastening part, and a tubular portion 48 for extending into the sleeve 44 of the first casing part 22a. The first and second casing parts 22a, 22b are attached together. For example, the first and second casing parts 22a, 22b may be attached together by adhesive, or the sleeve 44 can have an internal thread and the tubular portion can have an external thread for engaging with internal thread. The first and second casing parts 22a, 22b keep the tension spring 80 in place.

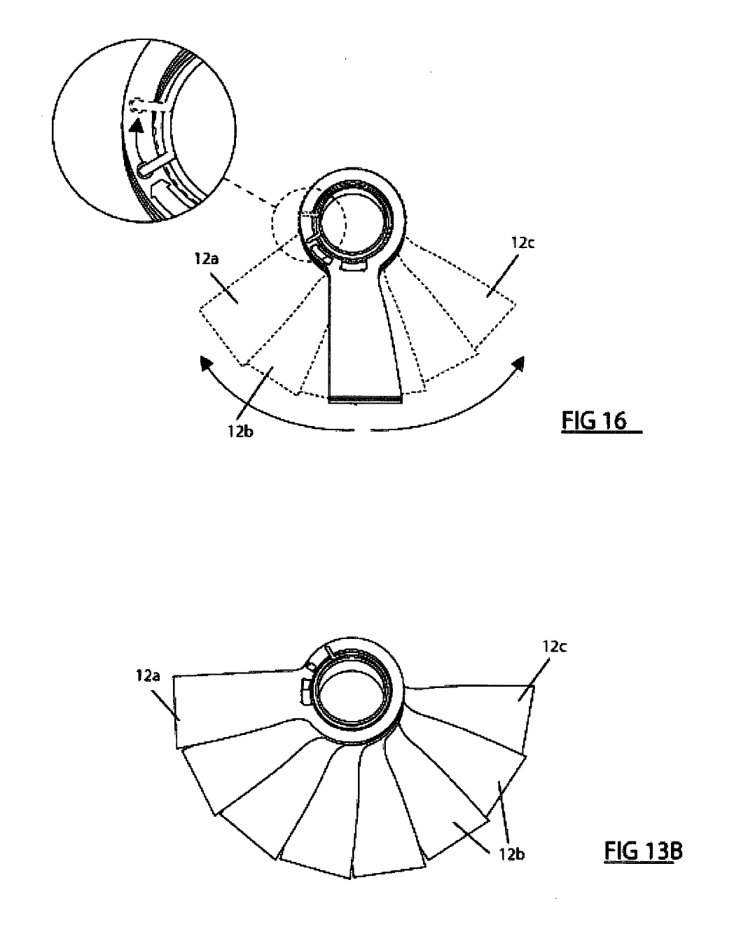

Referring to FIG. 16, in use, to expand the bowl 60, the button 62 is operated to disengage the locking tooth 64 from the aligned recesses 66 of the fastening parts. The torsion spring 80 then acts to cause the bowl 90 to expand. The first leaf 12a slides away from the adjacent middle leaf 12b. When the first leaf 12a is slid to the extent that the stop portion 36 of the intermediate leaf 12b adjacent the first leaf 12a abuts against the portion of the plate 26 of the first fastening part surrounding the slit 32 of that first fastening part, further sliding of the first leaf 12a causes the adjacent intermediate leaf 12b to slide over the next adjacent intermediate leaf 12b. As the leaves 12a-c are spread out, they flex to a bowl-shape due to the shape of the leaves, particularly the shape of the edge that abuts a respective adjacent leaf. Thus, the leaves 12a-c spread out sequentially to form the bowl shape. The torsion spring 80 urges the bowl 90 into the expanded configuration, thereby aiding sliding action.

The bowl 90 is collapsed by manually pushing the leaves 12a-c together. When the leaves 12a-c overlie each other so that the recess 66 of each leaf 12a-c is aligned, the locking tooth 64 is moved by the spring to engage into the recess 66, thereby to prevent relative movement of the leaves 12a-c. The spring also causes the button 62 to return to its non-depressed position.

In this embodiment each fastening assembly includes a lock mechanism, but, as will be appreciated, in other embodiments a lock mechanism may only be provided in one of the fastening assemblies.

In a variant, the locking mechanism may be configured to lock the colander or bowl into the expanded configuration. In this case, the leaves may be biased by the resilient member such that the colander 60 is biased to the collapsed configuration.

The material of the leaves of the bowl 50 may be thinner than the material of the colander to compensate for increased rigidity caused by the absence of holes.

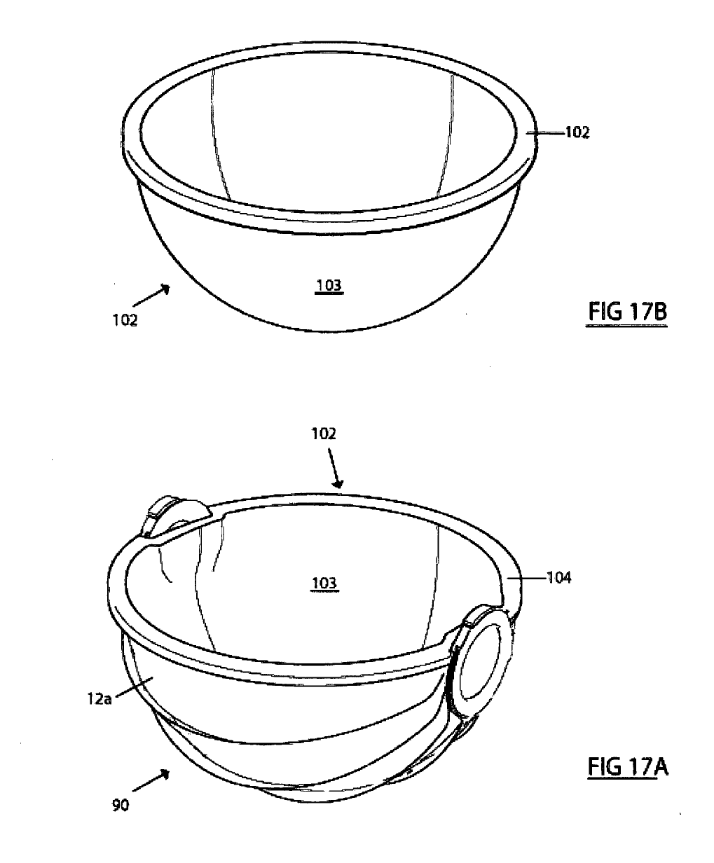

As indicated in FIG. 17A, the bowl 90 described above may optionally be provided with a cover 102 covering the interior surface of the bowl 90. The cover 102 is provided separately from the bowl and is shown in FIG. 17B. The cover 102 comprises a membrane 103 and a rigid lip 104 that is attachable around an edge of the bowl 90. The lip 104 includes a groove (not shown), into which the edge of the bowl 90 grippingly engages. After the bowl has been expanded, the cover 102 is located on the bowl 90.

The cover may be made of silicon membrane. The cover 102 adds to the aesthetic appeal of the bowl. Also, the cover 102 ensures that the bowl is liquid-tight. Further, the lip 104 may serve as a guard, to prevent potential for injury if the edges of the first and last leaves are sharp. It will be appreciated that only one cover is necessary for the bowl to be liquid-tight.

Preferably the materials used are food grade so that the collapsible container can be used with food. For example, the container may be formed of stainless steel, food grade plastic or a combination thereof. Instead of stainless steel, aluminium or titanium or a silicon based material may be used.

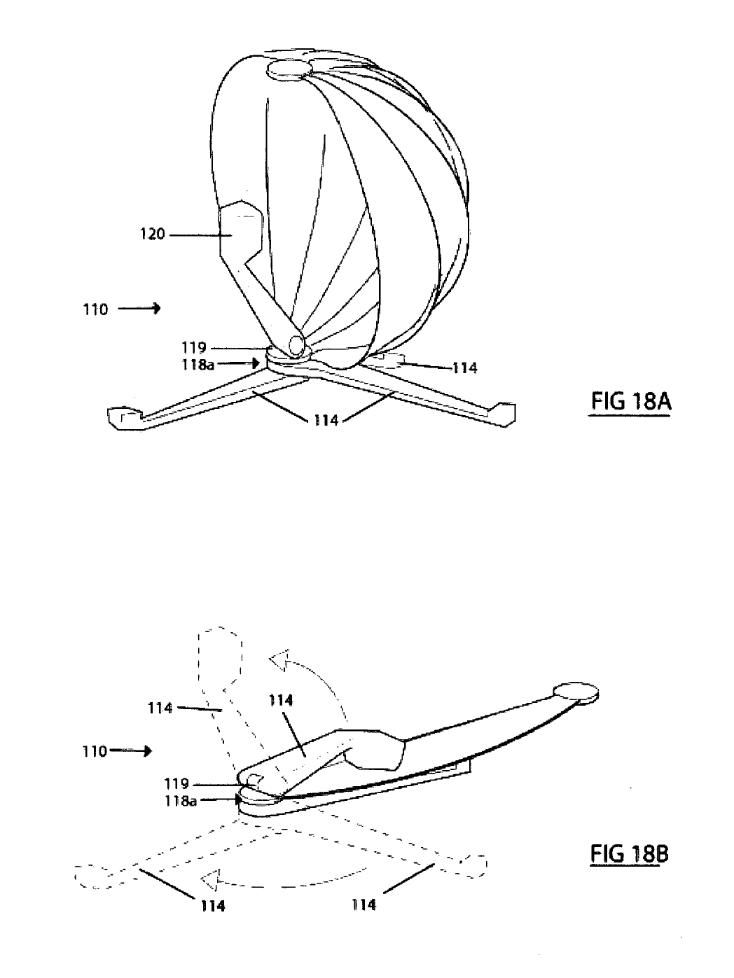

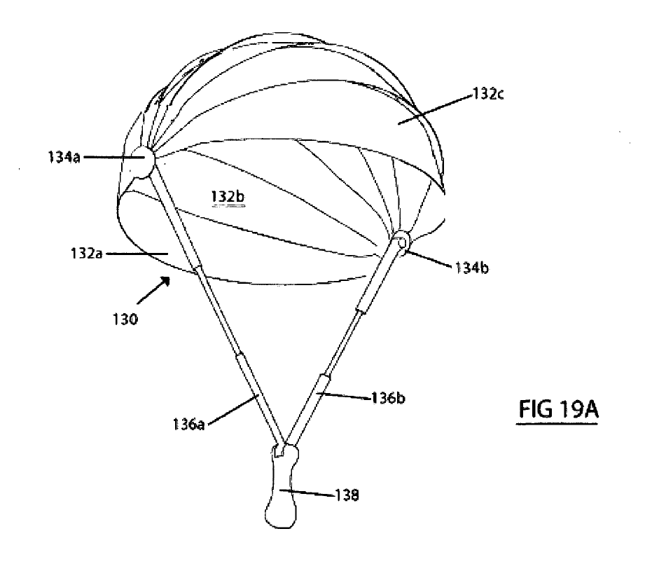

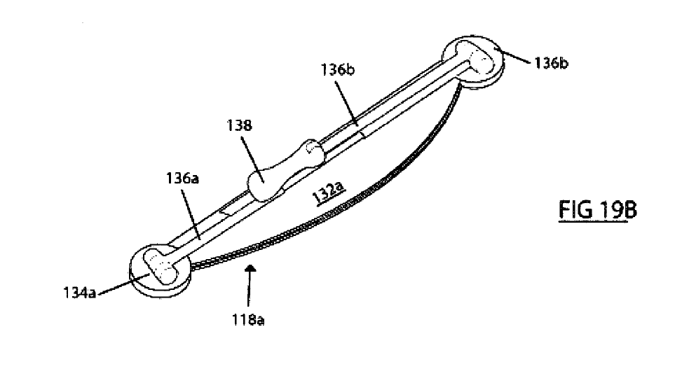

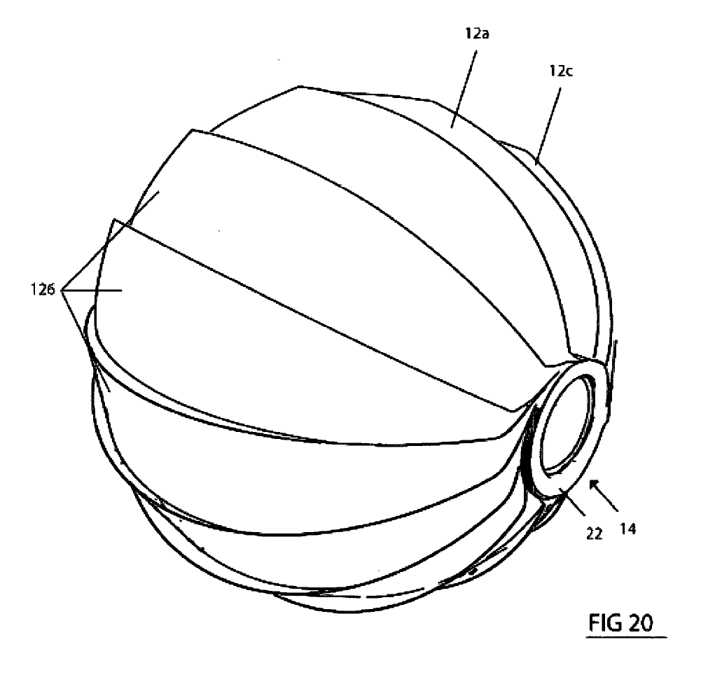

Referring to FIGS. 18A and 18B, in another embodiment, a parabolic satellite dish 110, which is reconfigurable between a use configuration in which it can receive signals, and a compacted configuration for transit or storage, comprises a dish portion 112. Although details of the fastening assemblies are not shown, the fastening assemblies can be functionally constructed in the same manners as the bowl described above, with or without a locking mechanism.

As shown in FIG. 18A, in an expanded configuration, a stand in the form of a tripod comprising three legs 114 is attached to an outer side of a casing 118a of one of the fastening assemblies. Each leg 114 can be pivoted so that, when the dish portion 112 is collapsed, as shown in FIG. 18B, each leg 116 is aligned with the length of the collapsed dish portion 116.

The dish 110 also includes a feedhorn 120 for receiving signals reflected by the dish portion 112. The feedhorn 120 is carried by an arm 122. The arm 122 is hingedly mounted on an inner side 119 of the casing 118a. In the expanded configuration, the arm 122 is arranged to hold the feedhorn 120 in a position to receive reflected signals. In a collapsed configuration, the arm 122 and the feedhorn 120 are located pressed against the collapsed dish portion 112. A communications line (not shown) extends from the feedhorn 120 to a port (not shown) in the arm 122, at which signals received can be output.

To reconfigure the dish 110 from the compacted configuration to the use configuration, the legs 114 are spread to form the tripod, the arm 122 is pivoted into an extended position, and the dish portion 112 is expanded like the bowls and colanders described above.

To reconfigure the dish 110 to the compacted configuration, the dish portion 112 is collapsed in the same manner as the bowls and colanders described above and the legs 114 are brought into respective alignment and also aligned with the length of the collapsed dish portion 112, and then the arm 122 is collapsed to extend adjacent the collapsed dish portion 112.

The inner surface of the dish is of reflective material. The kind of material that reflects depends on application.

In another embodiment (not shown), for application in photography, a light reflector may include a dome to direct light to a particular subject or scene. Alternatively, the dome can also be incorporated in a lamp as a light reflector. Where the dome is incorporated in a lamp, the lamp may further include a light source located in the dome, which may be held by an arm like the arm 122 described above which is hingedly attached to a casing of the dome.

Where the dome is incorporated in either the light reflector or a lamp it may include a tripod as described above or be otherwise configured with a stand. A screen allowing only partial transmission of light may be located over the opening of the dome. In each case, the dome is constructed and operable like the bowls and colanders described above

In an alternative, the dome may be formed of material that is only partially transmissible to light and may be configured as a lamp shade.

Referring to FIGS. 19A and 19B, in another embodiment an umbrella 130 has open and closed configurations. The umbrella 130 includes leaves 132a-c spreadable to form a dome. In FIG. 19A, the umbrella 130 is open with the leaves 132a-c spread. The dome is constructed and operable like the bowls and colanders described above. Although details of the fastening assemblies are not shown, the fastening assemblies can be functionally constructed in the same manners as the bowl described above, with or without a locking mechanism. The fastening assemblies include first and second casings indicated at 134a, 134b. The dome is constructed and operable like the bowls and colanders described above.

The umbrella 130 includes first and second struts 136a, 136b each having one end hingedly attached to a respective casing 134a, 134b and the other end of each attached to a handle 138. The first and second struts 136a, 136b are attached to the casings 134a, 134b and to the handle 138 so that when the umbrella 130 is in the open configuration shown in FIG. 19A, the arrangement of the struts relative to the dome of spread leaves 132a-c is fixed.

When the umbrella is 130 is to be closed, an end of the first strut 134a is detached from the handle 138 and attached to the second casing 134b. The second strut 134b is telescopic and includes a lock and release mechanism operable to allow a user to collapse it. The second strut 136h is then collapsed.

In alternatives, there are other ways that the umbrella 130 can be collapsed. For example, each first and second struts may be telescopic and each include a lock and release mechanism operable to allow their collapse. The lengths of the struts when collapsed may be such that one strut has to be detached from the handle in order for the struts to lie adjacent the collapsed dome, or may not have to be detachable.

Referring to FIG. 20, in another embodiment, a collapsible container when expanded is substantially ball-shaped. The collapsible container is configured like the container of the first embodiment, except with a greater number of leaves. Although not essential, the container may include means to attach the first and last leaves, so that the container can be locked in the expanded position. For example, the first leaf may include a hook and the last leaf may include an eyelet. The container may be used to contain food, and the food may be covered. Alternatively, the ball may be used in games. The ball may also be used to contain small pets such as hamsters, to allow them to roam—in this case the casing does not have an aperture therethrough through which the pet could escape and also preferably the leaves are transparent or include transparent portions.

In each of the embodiments and associated variants, the fastening parts are made to allow freedom of movement to prevent stress in the fastening assembly 14 on reconfiguring of the container. Thus the centres of the fastening part are aligned when collapsed, but may move on reconfiguring. The freedom of movement may be such that the centres of the annular plates can misalign by up to 2 mm.

It will be appreciated that various modifications may be made to the present invention beyond those mentioned above.

The thickness of the leaves may be determined based on the material used and the number, size and spacing of the holes so that the leaves have suitable resilient flexibility. Where the pieces comprising a leaf and associated fastening parts are made of plastic, the pieces may be formed in a mould. The engagement arm 30 may be formed bent, or may be bent after the piece is formed, depending on the characteristics of the plastic used.

In embodiments in which the container is in the form of a colander, it may be irrelevant whether liquid egresses between adjacent leaves 12a-c. However, this may not be the case when the container is for use as a bowl, depending on the intended use of the bowl. The shape of the leaves may be such that when in the expanded configuration, the edge of each of the first and intermediate leaves presses against the respective next leaf to form a liquid tight seal.

In an alternative embodiment, inclusion of pull lobes 24a, 24b or a locking mechanism is not required. In the collapsed and expanded configurations, the leaves may lock due to friction between the leaves and/or the geometry of the leaves. Flexing and sliding movement of the leaves expands the leaves, and the leaves may be pushed together to collapse the container.

The two-width slit 32 need not be present. Instead, the engagement arm 30 can slide in a recess (not shown) in an inner edge of the annular plate, in approximately the location that the slit 32 is shown in the embodiments described above.

The shape of the leaves 12a-c may be varied. The geometry should be such that the leaves can spread and arc to form a container. Different shapes will be required depending on the number of leaves and the shape of the desired container. The leaves need not be completely flat when container is collapsed.

Embodiments of the invention are not limited to bowls and colanders. Although a colander is described above, the container may be any kind of container suitable for straining. The container may be a measuring cup, which is essentially a bowl of predetermined volume or having a marker for indicating when filled to a predetermined volume.

The size, shape and arrangement of the drainage holes 16 may be modified. In particular, the holes may be many and small in order for the container to be used as a sieve, for example for sieving of rice. Sections of the leaves may be formed of a mesh. In this case, each leaf may initially be formed with an aperture or recess in it, and a piece of mesh may be attached over the aperture or recess. Such a straining device may be used to sift flour or powder.

The embodiments described above may be such that the container can be expanded in either direction. Thus, the surface of the leaves referred to above as the inner surface may in fact form the exterior surface of the container and the surface referred to as the outer surface may in fact form the inner surface of the container.

Embodiments of the invention are not limited to containers. In other embodiments, a protector or cover (not shown) may include an article constructed in the same manner as the bowl described above. The umbrella described above is an example of such a protector or cover. The protector or cover may be for use in catering, for covering food and drink. A temporary, portable shelter might also be constructed with a domed roof formed in the same manner as the bowl described above.

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein, and without limitation to the scope of the claims. The applicant indicates that aspects of the present invention may consist of any such individual feature or combination of features. In view of the foregoing description it will be evident to a person skilled in the art that various modifications may be made within the scope of the invention.

1. A collapsible, dome-shaped straining device, comprising a plurality of semi-rigid, elongate leaves each having a first end and a second end, wherein the first ends are attached together and the second ends are attached together, and wherein the leaves are moveable to reconfigure the straining device from one to the other of: an expanded configuration in which the leaves are spread to form a dome shape, and a collapsed configuration.

2. A straining device according to claim 1, wherein each leaf is less curved longitudinally in the collapsed configuration than in the expanded configuration.

3. A straining device according to claim 1, wherein in the collapsed configuration the leaves substantially overlie.

4. A straining device according to claim 1, wherein the straining device, when in the expanded configuration, is self-supporting.

5. A straining device according to claim 1, wherein the height of the straining device in the collapsed configuration is less than a quarter of the height of the straining device in the expanded configuration, and the width of the straining device in the collapsed configuration is less than the width of the straining device in the expanded configuration.

6. A straining device according to claim 1, wherein the leaves arc in the expanded configuration and are substantially flat in the collapsed configuration.

7. A straining device according to claim 1, further comprising first attachment means for attaching the first ends of the leaves, and second attachment means for attaching the second ends of the leaves, wherein:
the first attachment means comprises, for each leaf, a first attachment part attached to the first end of the respective leaf, the first attachment parts being arranged to attach the first ends of the leaves together, wherein each of the first attachment parts permits the leaves to respectively pivot for reconfiguring of the straining device, and further wherein:
the second attachment means comprises, for each leaf, a second attachment part attached to the second end of the respective leaf, the second attachment parts being arranged to attach the second ends of the leaves together, wherein each of the second attachment parts permits the leaves to respectively pivot for reconfiguring of the straining device.

8. A straining device according to claim 7, wherein at least one of the first and second attachment means comprises a handle.

9. (canceled)

10. A straining device according to claim 7, wherein:
the first attachment parts include engagement arms and means for engaging engagement arms, wherein the engagement arms of the first attachment parts are each configured to engage with the engaging means of an adjacent one of the first attachment parts, and the means for engaging are each configured to engage with the engaging arm of another adjacent one of the first fastening parts, and further wherein:
the second attachment parts include engagement arms and means for engaging engagement arms, wherein the engagement arms of the second attachment parts are each configured to engage with the engaging means of an adjacent one of the second attachment parts, and the means for engaging are each configured to engage with the engaging arm of another adjacent one of the second fastening parts.

11. (canceled)

12. A straining device according to claim 10, wherein each attachment part is engaged with the one or two adjacent attachment parts, and wherein:
the leaves comprise a first, at least one intermediate and a last leaves, and wherein movement of the first of the leaves in an expansion direction relative to the last of the leaves causes movement of the at least one intermediate leaf in said direction until the straining device is fully expanded, and further wherein:
the leaves include a plurality of the intermediate leaves, and wherein the intermediate leaves are pulled sequentially from the intermediate leaf adjacent the first leaf to the intermediate leaf adjacent the last leaf until the straining device is fully expanded.

13. (canceled)

14. (canceled)

15. A straining according to claim 7, wherein each leaf and the respective first attachment part and respective second attachment part are formed of a single piece of material.

16. (canceled)

17. (canceled)

18. A straining device according to claim 1, wherein when the straining device is in the collapsed configuration, the geometry of the leaves prevents expansion, wherein the straining device expands on manual flexing of the leaves.

19. A straining device according to claim 7, wherein at least one of the attachment means further comprises a lock means for releasably locking the straining device in the collapsed configuration, and further wherein the lock means is operable to release the lock means, whereupon the straining device can expand to the expanded configuration.

20. (canceled)

21. A straining device according to claim 1, wherein the plurality of leaves comprises 5 to 12 leaves.

22. A straining device according to claim 1, wherein the leaves are shaped so that when the straining device is in the expanded configuration, an edge of at least some of the leaves substantially abuts an adjacent one of the leaves; and further wherein the leaves are arranged to spread so as to, in the expanded configuration, enclose contents of the straining device.

23. A straining device according to claim 1, wherein the resilient flexibility of the leaf along the length of each leaf is predetermined so that, when the straining device is in the expanded configuration, each leaf has a predetermined curvature.

24. A straining according to claim 23, wherein the resilient flexibility along the leaf is substantially constant.

25. (canceled)

26. (canceled)

27. (canceled)

28. (canceled)

29. (canceled)

30. (canceled)

31. A straining device according to claim 1, further comprising a guard over outer edges of the first and last of the leaves.

32. (canceled)

33. (canceled)

34. (canceled)

35. (canceled)

36. (canceled)

37. (canceled)

38. (canceled)

39. A container comprising a collapsible, dome-shaped straining device, the straining device comprising a plurality of semi-rigid elongate leaves each having a first end and a second end, wherein
the first ends are attached together and the second ends are attached together;
the leaves are moveable to reconfigure the straining device from one to the other of: an expanded configuration in which the leaves are spread to form a dome shape, and a collapsed configuration; and
the leaves arc in the expanded configuration and are substantially flat in the collapsed configuration.

40. A bowl or colander comprising a collapsible, dome-shaped article, the article comprising a plurality of semi-rigid elongate leaves each having a first end and a second end, wherein
the first ends are attached together and the second ends are attached together;
the leaves are moveable to reconfigure the article from one to the other of: an expanded configuration in which the leaves are spread to form a dome shape, and a collapsed configuration;
each leaf is less curved longitudinally in the collapsed configuration than in the expanded configuration, and further wherein:
the leaves arc in the expanded configuration and are substantially flat in the collapsed configuration.
